(19) United States
(12) Patent Application Publication
(10) Pub. No.: US 2025/0200688 A1
(43) Pub. Date: Jun. 19, 2025

(54) BOARDING AND ALIGHTING NUMBER PREDICTION DEVICE

(71) Applicant: NTT DOCOMO, INC., Tokyo (JP)

(72) Inventors: Akinari SAKAI, Chiyoda-ku (JP); Yusuke NAKAMURA, Chiyoda-ku (JP); Akira YAMADA, Chiyoda-ku (JP); Takashi SUZUKI, Chiyoda-ku (JP)

(73) Assignee: NTT DOCOMO, INC., Tokyo (JP)

(21) Appl. No.: 18/846,932

(22) PCT Filed: Mar. 24, 2023
(86) PCT No.: PCT/JP2023/011912

§ 371 Date: Sep. 13, 2024

(30) Foreign Application Priority Data
May 17, 2022 (JP) 2022-080786

(51) Int. Cl. G06Q 50/40; H04L 67/50

(52) U.S. Cl. CPC G06Q 50/40; H04L 67/535

(57) ABSTRACT

An object is to predict the number of boarding passengers or the number of alighting passengers that is more accurate. A boarding and alighting number prediction device (1) includes a prediction unit (12) predicting a boarding and alighting number prediction value that is a predicted value of a boarding and alighting number that is the number of boarding passengers or the number of alighting passengers at a stop on the basis of a real-time prediction value that is a predicted value of the boarding and alighting number based on position information relating to current positions of at least some of the passengers and past result values that are values based on result values of past boarding and alighting numbers. The prediction unit (12) may predict the boarding and alighting number prediction value by respectively weighting the real-time prediction value and the past result values.

### TECHNICAL FIELD

One aspect of the present disclosure relates to a boarding and alighting number prediction device that predicts the number of passengers getting on or off at a stop.

### BACKGROUND ART

In Patent Literature 1 below, a dispatch management device that estimates the number of passengers expected to alight by analyzing captured images of the inside of the cabin of a congested bus to identify clothing or belongings of the passengers is disclosed.

### CITATION LIST

### Patent Literature

Patent Literature 1: Japanese Unexamined Patent Publication No. 2021-51431

### SUMMARY OF INVENTION

### Technical Problem

In the dispatch management device described above, the number of passengers expected to alight is estimated using clothing or belongings of passengers, which are relatively unrelated to alighting, and thus cannot be considered as an accurate estimation. Therefore, it is desirable to predict the number of passengers boarding or alighting more accurately.

### Solution to Problem

According to one aspect of the present disclosure, there is provided a boarding and alighting number prediction device including a prediction unit predicting a boarding and alighting number prediction value that is a predicted value of a boarding and alighting number that is the number of boarding passengers or the number of alighting passengers at a stop on the basis of a real-time prediction value that is a predicted value of the boarding and alighting number based on position information relating to current positions of at least some of the passengers and past result values that are values based on result values of past boarding and alighting numbers.

In such an aspect, since the boarding and alighting number is predicted on the basis of the real-time prediction value and the past result values, a number of boarding passengers or a number of alighting passengers that is more accurate can be predicted.

### Advantageous Effects of Invention

According to one aspect of the present disclosure, the number of passengers boarding or alighting can be predicted more accurately.

### BRIEF DESCRIPTION OF DRAWINGS

FIG. 1 A diagram for describing a bus application.

FIG. 2 A diagram illustrating one example of the functional configuration of a boarding and alighting number prediction device according to an embodiment.

FIG. 3 A diagram for describing boarding of a bus application user at a bus stop.

FIG. 4 A diagram for describing alighting of a bus application user inside a bus.

FIG. 5 A sequence diagram illustrating one example of a sending-off process executed by a boarding and alighting number prediction device according to an embodiment.

FIG. 6 A flowchart illustrating one example of an update process executed by a boarding and alighting number prediction device according to an embodiment.

FIG. 7 A diagram illustrating one example of the hardware configuration of a computer used in a boarding and alighting number prediction device according to an embodiment.

### DESCRIPTION OF EMBODIMENTS

Hereinafter, an embodiment of the present disclosure will be described in detail with reference to the drawings. In description of the drawings, the same reference signs will be assigned to the same elements, and duplicate description will be omitted. In addition, the embodiment of the present disclosure in the following description is a specific example of the present invention, and the present invention is not limited to such an embodiment unless there is description for the purpose of limiting the present invention.

A boarding and alighting number prediction device 1 according to the embodiment is a computer device that predicts a boarding and alighting number prediction value that is a predicted value of a boarding and alighting number that is the number of passengers boarding or alighting at stops for public transportation operating regularly (approximately on time).

The public transportation, for example, is a bus, a train, a ship, an airplane, and the like. (One or more) public transportations that are targets for the boarding and alighting number prediction device 1 are public transportations set by a user of the boarding and alighting number prediction device 1 in advance, public transportations designated by a user of the boarding and alighting number prediction device 1, and the like. In a case in which public transportation is designated by a user of the boarding and alighting number prediction device 1, for example, the user appropriately inputs a public transportation ID or the like used for identifying the public transportation to the boarding and alighting number prediction device 1. Description of this input will be appropriately omitted. In this embodiment, although the boarding and alighting number prediction device 1 will be mainly described for one predetermined public transportation as its target, the configuration is not limited thereto.

Stops are predetermined places at which public transportation stops for allowing passengers to board and alight. (One or more) stops that are targets for the boarding and alighting number prediction device 1 are stops set by a user of the boarding and alighting number prediction device 1 in advance, stops designated by a user of the boarding and alighting number prediction device 1, or the like. In a case in which a user of the boarding and alighting number prediction device 1 designates a stop, for example, the user appropriately inputs a stop ID or the like for identifying the stop to the boarding and alighting number prediction device 1. Description of this input will be appropriately omitted. In this embodiment, although the boarding and alighting number prediction device 1 will be mainly described to have one predetermined stop as its target, the configuration is not limited thereto.

In this embodiment, public transportation and a stop are respectively assumed to be a bus and a bus stop but are not limited thereto and may be a train and a station, a ship and a dock, an air plane and an airport, or the like. In a case in which another public transportation is used, a bus and a bus stop and the like according to this embodiment may be appropriately substituted with objects corresponding to this public transportation.

The number of passengers is the number of persons boarding the bus at a bus stop. The number of passengers (currently) having boarded the bus will be written as the number of persons on board to be distinguished from the number of passengers.

The number of alighting passengers is the number of passengers getting off the bus at the bus stop.

Premises of this embodiment will be described.

It is assumed that each bus perceives a correct number of passengers on board and a correct boarding/alighting number. For example, by including various sensors inside the bus, the number of passengers on board and the boarding/alighting number may be perceived on the basis of these sensors, by including an indoor camera in the bus, the number of passengers on board and the boarding/alighting number may be perceived on the basis of a captured image acquired by this indoor camera, or the number of passengers on board and the boarding/alighting number may be perceived on the basis of behaviors of passengers at the time of boarding the bus and at the time of getting off the bus (acquisition of a numbered ticket, a contact of an IC card, payment, and the like).

At least some of (some or all of) passengers are assumed to use a bus application that is an application or a service relating to buses. In the bus application, various kinds of information are registered from a bus application user who is a user of the bus application, and the bus application outputs various kinds of information that is beneficial to the bus application user. An application in the bus application may be installed in a mobile device (for example, a smartphone) held by a passenger in advance. A service in the bus application may be used through a browser application of a mobile device held by a passenger.

In the bus application, one or more bus stops (destinations) that are regularly used by a bus application user may be registered.

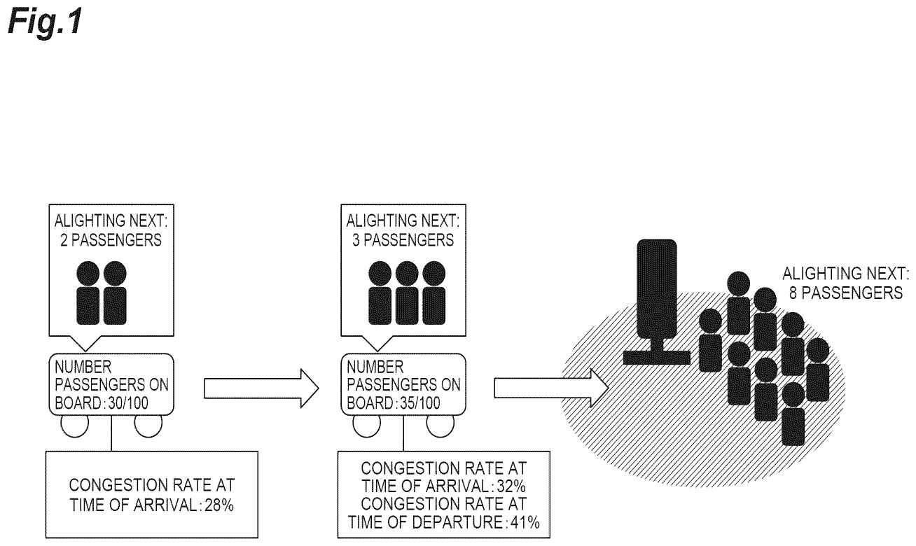

The bus application may present a congestion rate of an arriving bus to a bus application user. In other words, the bus application may be appropriately called as a bus congestion rate checking application/service. FIG. 1 is a diagram for describing a bus application. For example, in a case in which the number of passengers on board in a traveling bus (with a seating capacity of 100 passengers) is 30, and the number of passengers to get off at a next bus stop is predicted to be 2, the bus application presents 28% (=(30−2)/100) to the bus application user as an arrival-time congestion rate. In addition, for example, in a case in which the number of passengers on board in this bus is 35, and the number of passengers to get off at a next bus stop is predicted to be 3, the bus application presents 32% (=(35−3)/100) to the bus application user as an arrival-time congestion rate, and in a case in which the number of passengers to board at a next bus stop is predicted to be 8, the bus application presents 40% (=(35−3+8)/100) to the bus application user as a departure-time congestion rate.

A bus application may have functions of checking in at a geofence constructed at each bus stop and checking out from the geofence. Checking-in represents that a bus application user is present near a target bus stop (the bus application user is waiting for a bus, has passed this bus stop, or the like). Checking-out represents that no bus application user is present near a target bus stop (the bus application user is not waiting for a bus, has passed this bus stop, or the like).

The premises of this embodiment have been described as above.

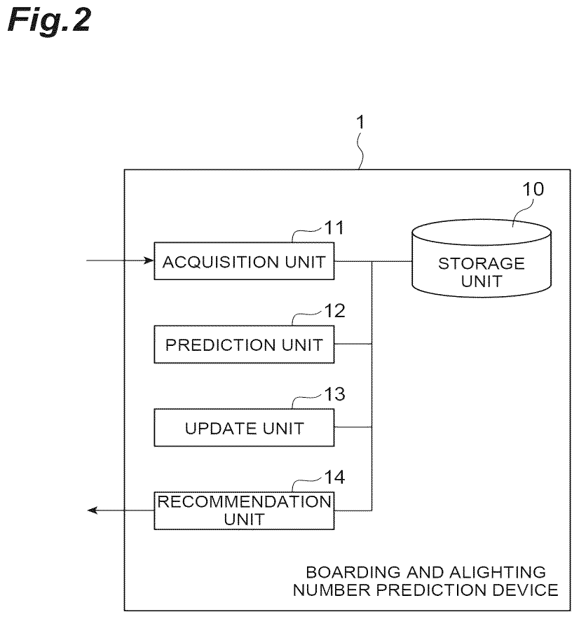

FIG. 2 is a diagram illustrating one example of the functional configuration of the boarding and alighting number prediction device 1. As illustrated in FIG. 1, the boarding and alighting number prediction device 1 is configured to include a storage unit 10, an acquisition unit 11, a prediction unit 12 (prediction unit), an update unit 13 (update unit), and a recommendation unit 14 (recommendation unit).

Although each functional block of the boarding and alighting number prediction device 1 is assumed to function inside the boarding and alighting number prediction device 1, the configuration is not limited thereto. For example, some of the functional blocks of the boarding and alighting number prediction device 1 may function while transmitting/receiving information to/from the boarding and alighting number prediction device 1 inside a computer device that is a computer device different from the boarding and alighting number prediction device 1 and is connected to the boarding and alighting number prediction device 1 through a network. In addition, some of the functional blocks of the boarding and alighting number prediction device 1 may be omitted, a plurality of functional blocks may be integrated into one functional block, or one functional block may be broken up into a plurality of functional blocks.

Hereinafter, each function of the boarding and alighting number prediction device 1 illustrated in FIG. 2 will be described.

The storage unit 10 stores arbitrary information used in calculation and the like in the boarding and alighting number prediction device 1 and a result of calculation in the boarding and alighting number prediction device 1, and the like. The information stored by the storage unit 10 may be appropriately referred to using each function of the boarding and alighting number prediction device 1.

The acquisition unit 11 acquires arbitrary information used in calculation and the like in the boarding and alighting number prediction device 1. The acquisition unit 11 may acquire information from another device or a bus application through a network or may acquire information stored using the storage unit 10. The acquisition unit 11 may output the acquired information to the prediction unit 12, the update unit 13, or the recommendation unit 14 or may cause the storage unit 10 to store the acquired information.

As described above, the acquisition unit 11 may acquire the number of passengers on board and the boarding and alighting number using various sensors included inside the bus.

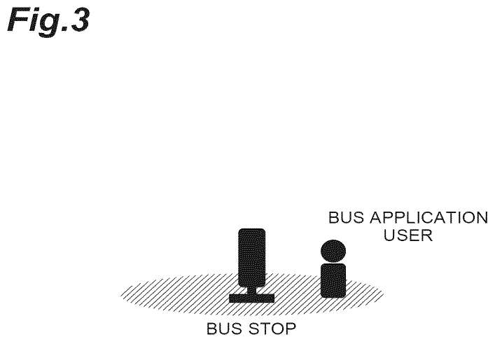

The acquisition unit 11 may acquire the number of boarding persons (the number of persons to board) of the bus application user at each bus stop. FIG. 3 is a diagram for describing boarding of a bus application user at a bus stop. In FIG. 3, shading near a bus stop represents a geofence built at this bus stop. A bus application user who has checked in at a specific bus stop and has not checked out for a predetermined time (for example, 5 minutes) is determined to be a person to board at the bus by the boarding and alighting number prediction device 1. On the basis of this determination, the acquisition unit 11 acquires the number of boarding persons of the bus application users at each bus stop.

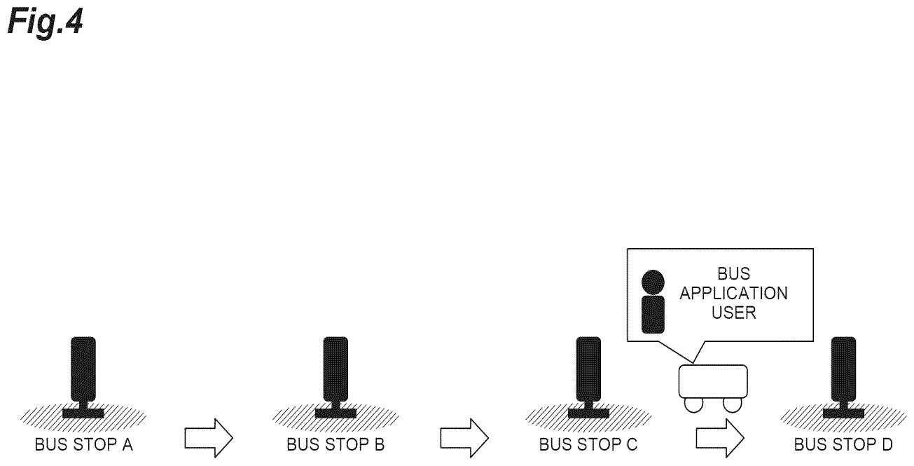

The acquisition unit 11 may acquire the number of alighting passengers (the number of passengers to alight) of bus application users inside the bus. FIG. 4 is a diagram for describing alighting of a bus application user inside a bus. Similar to FIG. 3, shade near each bus stop represents a geofence built at this bus stop in FIG. 4. In a case in which the boarding and alighting number prediction device 1 determines that a bus application user has recently checked in at each bus stop (bus stop A, bus stop B, bus stop C, and the like) in a bus route including a bus stop (a bus stop D, a destination) registered in advance by the bus application user, this bus application user is determined as being on board in the bus by the boarding and alighting number prediction device 1. In addition, it is determined by the boarding and alighting number prediction device 1 that, after a bus application user checks in at a bus stop immediately previous to a bus stop registered in advance by the bus application user, this bus application user will alight at the next stop. On the basis of these determinations, the acquisition unit 11 acquires the number of alighting passengers of bus application users inside the bus.

The prediction unit 12 predicts a boarding and alighting number prediction value that is a predicted value of the boarding and alighting number that is the number of boarding passengers or the number of alighting passengers at a bus stop (a stop place) on the basis of a real-time predicted value that is a predicted value of the boarding and alighting number based on position information relating to current positions of at least some of passengers and past result values that are values based on result values of past boarding and alighting numbers.

The prediction unit 12 may predict a boarding and alighting number prediction value by respectively weighting the real-time predicted value and the past result values. The real-time predicted value and the past result values may target the same day of week or the same time period. The position information may be information representing that mobile devices held by at least some of passengers have checked in at a certain bus stop (a stop place). The prediction unit 12 may calculate a real-time predicted value on the basis of a proportion providing position information among passengers.

The prediction unit 12 may output the predicted boarding and alighting number prediction value to the update unit 13 and the recommendation unit 14 or may cause the storage unit 10 to store the boarding and alighting number prediction value.

The update unit 13 updates weights on the basis of a difference between the boarding and alighting number prediction value and an actual boarding and alighting value. The boarding and alighting number prediction value may be input by the prediction unit 12 or may be stored using the storage unit 10. The actual boarding and alighting number may be acquired by the acquisition unit 11 or may be stored using the storage unit 10. Weights may be stored using the storage unit 10. The update unit 13 may cause the storage unit 10 to store (overwrite) updated weights. The weights updated (generated) by the update unit 13 are used for prediction performed thereafter by the prediction unit 12.

Hereinafter, details of the processes performed by the prediction unit 12 and the update unit 13 will be described.

First, prediction and update of the number of boarding passengers at a bus stop will be described.

An average number of boarding passengers per bus for each specific bus stop, each day, and each time frame will be represented using the following variables.

$${Geton}_{X \_ dayofweek \_ time}^{Average} \qquad [ Math . 1 ]$$

Here, X represents a target bus stop, dayofweek represents day, and time represents a time frame.

An average number of alighting passengers of bus application users per bus for each bus stop of a specific route, each day, and each time frame is represented using the following variables.

$${Geton}_{X \_ dayofweek \_ time}^{Average} \qquad [ Math . 1 ]$$

A proportion of bus application users per bus for each bus stop of a specific route, each day, and each time frame is calculated using the following equation.

$${Geton}_{X \_ dayofweek \_ time}^{App \_ Ave} \qquad [ Math . 2 ]$$

$${Rate\_Geton}_{X \_ dayofweek \_ time}^{Average} = \frac{{Geton}_{X \_ dayofweek \_ time}^{App \_ Ave}}{{Geton}_{X \_ dayofweek \_ time}^{Average}} \qquad [ Math . 3 ]$$

The number of bus application users who are during checking-in at the bus stop X will be represented using the following variables.

$${Geton}_{X \_ mmddhh}^{App \_ Measured \_ num} \qquad [ Math . 4 ]$$

Here, mmddhh represents a date and a time frame, and num represents which bus it is during the time frame of this date.

A predicted value of the number of passengers boarding at a bus stop that is acquired using the prediction unit 12 is predicted (calculated) using the following equation.

$${Geton}_{X \_ mmddhh}^{Pred \_ num} = \frac{\begin{matrix}{W}_{X \_ dayofweek}^{1} \\ ( {Geton}_{X \_ mmddhh}^{App \_ Measured \_ num} \frac{1}{{Rate\_Geton}_{X \_ dayofweek \_ time}^{Average}} )\end{matrix} + {W}_{X \_ dayofweek}^{2} ( {Geton}_{X \_ dayofweek \_ time}^{Average} )}{( {W}_{X \_ dayofweek}^{1} + {W}_{X \_ dayofweek}^{2} )} \qquad [ Math . 5 ]$$

Here, W¹ and W² represents weights. The weights represent which of the number of bus application users who are on board in a current bus that have been measured and past result data is used with priority.

An actual number of boarding passengers will be represented using the following variables.

$${Geton}_{X \_ mmddhh}^{Measured \_ num} \qquad [ Math . 6 ]$$

An error between a predicted value and an actual value is calculated using the following equation.

$${Error}_{X \_ dayofweek \_ time}^{count} = \vert {Geton}_{X \_ mmddhh}^{Measured \_ num} + {Sentoff}_{X \_ mmddhh}^{App \_ Measured \_ num} - {Geton}_{X \_ mmddhh}^{Pred \_ num} \vert \qquad [ Math . 7 ]$$

Here, count represents which instance of data it is in the bus stop of the specific route, the day, and the time frame (counted regardless of the date), and Sentoff represents the number of bus application users who have been actually sent off.

Update of weights using the update unit 13 is performed by performing optimization such that an error between a predicted value and an actually-measured value becomes small. More specifically, the following value is minimized under constraint conditions represented in the following equation.

$${W}_{X \_ dayofweek}^{1} + {W}_{X \_ dayofweek}^{2} = 1 \qquad [ Math . 8 ]$$

$${\sum }_{count = 1}^{N} {Error}_{X \_ dayofweek \_ time}^{count} \qquad [ Math . 9 ]$$

Next, prediction and update of the number of alighting passengers at a bus stop will be described.

The average number of alighting passengers per bus for each bus stop of a specific route, each day, and each time frame will be represented using the following variables.

$${Getoff}_{XtoY \_ dayofweek \_ time}^{Average} \qquad [ Math . 10 ]$$

Here, X represents a previous departure bus stop, Y represents a next arrival bus stop, dayofweek represents day, and time represents a time frame.

The average number of alighting passengers of bus application users per bus for each bus stop of a specific route, each day, and each time frame will be represented using the following variables.

$${Getoff}_{XtoY \_ dayofweek \_ time}^{App \_ Ave} \qquad [ Math . 11 ]$$

A proportion of bus application users per bus for each bus stop of a specific route, each day, and each time frame will be calculated using the following equation.

$${Rate\_Getoff}_{XtoY \_ dayofweek \_ time}^{Average} = \frac{{Getoff}_{XtoY \_ dayofweek \_ time}^{App \_ Ave}}{{Getoff}_{XtoY \_ dayofweek \_ time}^{Average}} \qquad [ Math . 12 ]$$

The number of passengers on board who have registered the bus stop Y will be represented using the following variables.

$${Getoff}_{XtoY \_ mmddhh}^{App \_ Measured \_ num} \qquad [ Math . 13 ]$$

Here, mmddhh represents a date and a time frame, and num represents which bus it is in the time frame of this date.

A predicted value of the number of alighting passengers at a bus stop that is performed using the prediction unit 12 is predicted (calculated) using the following equation.

$${Getoff}_{XtoY \_ mmddhh}^{Pred \_ num} = \frac{\begin{matrix}{W}_{XtoY \_ dayofweek}^{1} \\ ( {Getoff}_{XtoY \_ mmddhh}^{App \_ Measured \_ num} \frac{1}{{Rate\_Getoff}_{XtoY \_ dayofweek \_ time}^{Average}} )\end{matrix} + {W}_{XtoY \_ dayofweek}^{2} ( {Getoff}_{XtoY \_ dayofweek \_ time}^{Average} )}{( {W}_{XtoY \_ dayofweek}^{1} + {W}_{XtoY \_ dayofweek}^{2} )} \qquad [ Math . 14 ]$$

Here, W¹ and W² represent weights. The weights represent which of the number of bus application users who are on board in a current bus that have been measured and past result data is used with priority.

An actual number of alighting passengers will be represented using the following variables.

$${Getoff}_{XtoY \_ mmddhh}^{Measured \_ num} \qquad [ Math . 15 ]$$

An error between a predicted value and an actual value is calculated using the following equation.

$${Error}_{XtoY \_ dayofweek \_ time}^{count} = \vert {Getoff}_{XtoY \_ mmddhh}^{Measured \_ num} - {Getoff}_{XtoY \_ mmddhh}^{Pred \_ num} \vert \qquad [ Math . 16 ]$$

Here, count represents which instance of data it is in the bus stop of the specific route, the day, and the time frame (counted regardless of the date).

Update of weights using the update unit 13 is performed by performing optimization such that an error between a predicted value and an actually-measured value becomes small. More specifically, the following value is minimized under constraint conditions represented in the following equation.

$${W}_{XtoY \_ dayofweek}^{1} + {W}_{XtoY \_ dayofweek}^{2} = 1 \qquad [ Math . 17 ]$$

$${\sum }_{count = 1}^{N} {Error}_{XtoY \_ dayofweek \_ time}^{count} \qquad [ Math . 18 ]$$

The recommendation unit 14 recommends passengers waiting for boarding at a bus stop (stop place) to send off boarding on the basis of the boarding and alighting number prediction value predicted by the prediction unit 12. More specifically, in a case in which a bus arriving at a bus stop is predicted as being congested at the time of departure from this bus stop (a congestion rate at the time of departure exceeds a predetermined threshold), the recommendation unit 14 recommends passengers (or bus application users) waiting for boarding at this bus stop to send off boarding. In a case in which a bus arriving at a bus stop is predicted as being congested at the time of departure from this bus stop and in a case in which there is a following bus having vacancy (a congestion rate at the time of departure does not exceed a predetermined threshold), the recommendation unit 14 may recommend passengers (or bus application users) waiting for boarding at this bus stop to send off boarding.

The recommendation unit 14 calculates a congestion rate, more specifically, a congestion rate at the time of departure of a bus arriving next by adding a predicted number of boarding passengers at an arrival bus stop (a predicted value of the number of boarding passengers predicted by the prediction unit 12) to the number of on-board passengers of a bus arriving at a certain bus stop next and subtracting a predicted number of alighting passengers at the arrival bus stop (a predicted value of the number of alighting passengers predicted by the prediction unit 12) therefrom and dividing a sum thereof by the seating capacity.

For example, in the case of a bus A arriving at a bus stop X next, when the number of passengers on board of a bus moving toward the bus stop X is X₁, the number of passengers to board at the bus stop X is X₂, the number of passengers to alight at the bus stop X is X₃, and the seating capacity of the bus A is Xₘₐₓ, the recommendation unit 14 calculates the congestion rate of the bus A at the time of departure from the bus stop X using Equation “(X₁+X₂−X₃)/Xₘₐₓ”.

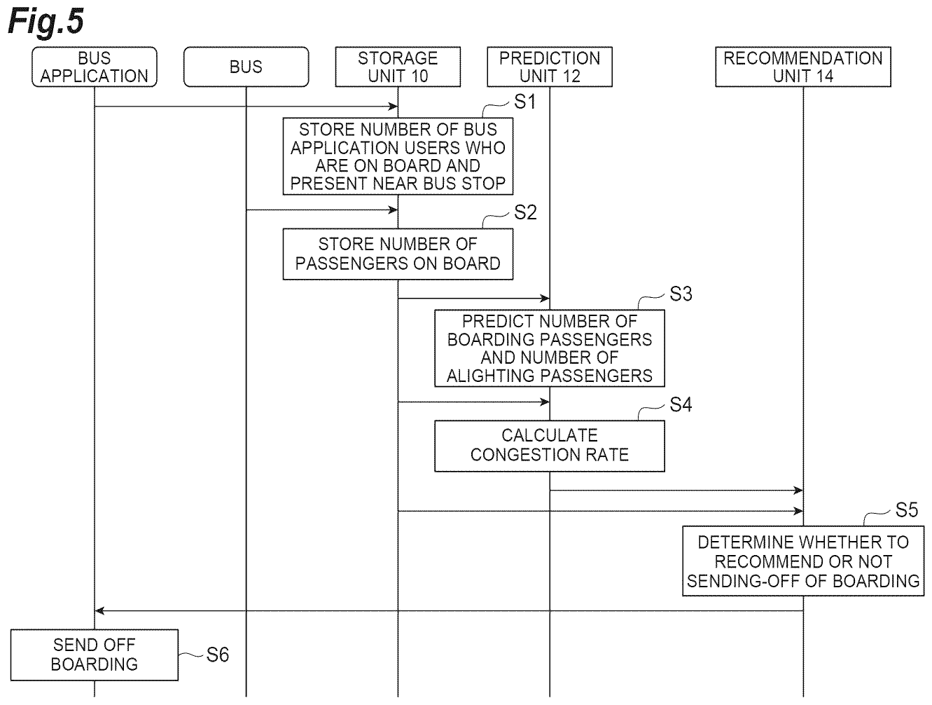

Subsequently, an example of a sending-off process executed by the boarding and alighting number prediction device 1 will be described with reference to FIG. 5. FIG. 5 is a sequence diagram illustrating one example of a sending-off process executed by the boarding and alighting number prediction device according to the embodiment.

First, the acquisition unit 11 acquires the number of bus application users (a bus application user number) who are on board or near a bus stop on the basis of the information from this bus application and stores the number of bus application users using the storage unit 10 (Step S1). Next, the storage unit 10 acquires the number of passengers on board on the basis of information from a bus and causes the storage unit 10 to store the number of passengers on board (Step S2). Next, the prediction unit 12 predicts the number of boarding passengers and the number of alighting passengers on the basis of information stored in the storage unit 10 (Step S3). Next, the prediction unit 12 calculates a congestion rate on the basis of the prediction result of S3 and the number of passengers on board that is stored using the storage unit 10 and the seating capacity (Step S4). Next, the recommendation unit 14 determines whether or not boarding is recommended to be sent off on the basis of the calculation result of S4 and following bus information stored using the storage unit 10 (Step S5). In a case in which recommendation is determined in S5, for example, in a case in which a bus planned to arrive next is predicted to be congested and there is a following bus having vacancy, the recommendation unit 14 recommends a bus application user to send off boarding (for example, displays indication representing recommendation of sending-off to a mobile device held by the bus application user), and the bus application user sends off boarding (Step S6).

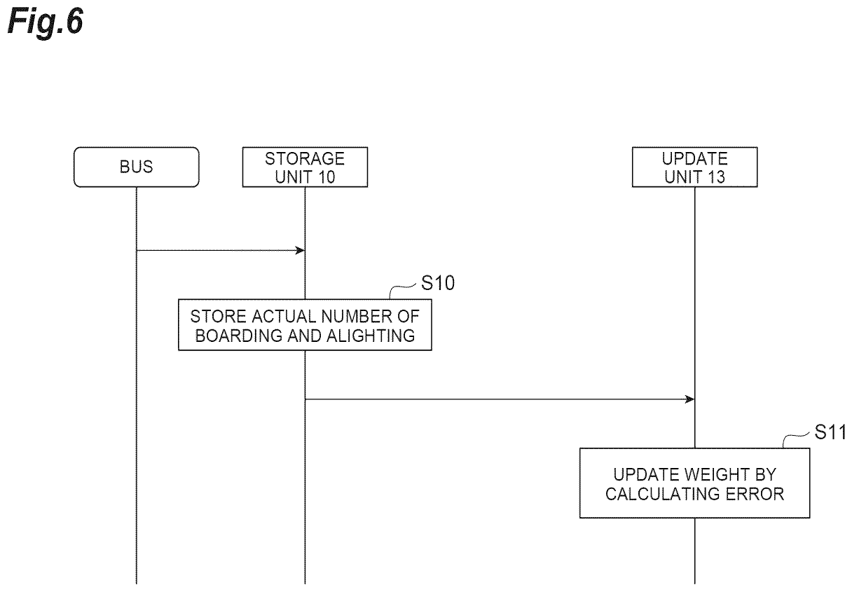

Subsequently, an example of an update process executed by the boarding and alighting number prediction device 1 will be described with reference to FIG. 6. FIG. 6 is a sequence diagram illustrating one example of an update process executed by the boarding and alighting number prediction device 1 according to the embodiment.

First, the acquisition unit 11 acquires an actual boarding and alighting number on the basis of information from a bus and causes the storage unit 10 to store the actual boarding and alighting number (Step S10). Next, the update unit 13 calculates an error on the basis of the information stored using the storage unit 10 and updates the weights (Step S11).

Subsequently, operations and effects of the boarding and alighting number prediction device 1 according to the embodiment will be described.

According to the boarding and alighting number prediction device 1, the prediction unit 12 predicts a boarding and alighting number prediction value that is a predicted value of a boarding and alighting number that is the number of boarding passengers or the number of alighting passengers at a stop on the basis of a real-time prediction value that is a predicted value of the boarding and alighting number based on position information relating to current positions of at least some of the passengers and past result values that are values based on result values of past boarding and alighting numbers. According to this configuration, the boarding and alighting number is predicted on the basis of a real-time predicted value and past result values, and thus the number of boarding passengers or the number of alighting passengers that is more accurate can be predicted.

In addition, according to the boarding and alighting number prediction device 1, the prediction unit 12 may predict the boarding and alighting number prediction value by respectively weighting the real-time prediction value and the past result values. According to this configuration, for example, by appropriately weighting the real-time prediction value and the past result values in accordance with the situations, the number of boarding passengers or the number of alighting passengers that is more accurate can be predicted.

In addition, according to the boarding and alighting number prediction device 1, an update unit 13 updating weights on the basis of a difference between the boarding and alighting number prediction value and the actual boarding and alighting number may be further included. According to this configuration, for example, when weighting is performed such that a difference between the boarding and alighting number prediction value and the actual boarding and alighting number becomes small, the number of boarding passengers or the number of alighting passengers that is more accurate can be predicted.

In addition, according to the boarding and alighting number prediction device 1, the real-time prediction value and the past result values may be targeted for a same day of week or a same time period. According to this configuration, for example, a real-time prediction value and a past result value in the same situation condition are used, and the number of boarding passengers or the number of alighting passengers that is more accurate can be predicted.

In addition, according to the boarding and alighting number prediction device 1, a recommendation unit 14 recommending the passengers waiting for boarding at the stop to send off boarding on the basis of the boarding and alighting number prediction value predicted by the prediction unit 12 may be further included. According to this configuration, for example, concentration of congestion in some buses can be prevented.

In addition, according to the boarding and alighting number prediction device 1, the position information may be information representing that mobile devices held by at least some of the passengers have checked in at certain stops. According to this configuration, when a check-in function is present, the boarding and alighting number prediction device 1 can be easily realized.

In addition, according to the boarding and alighting number prediction device 1, the prediction unit 12 may calculate the real-time prediction value on the basis of a proportion providing the position information among the passengers. According to this configuration, for example, even when all the passengers do not provide position information, the number of boarding passengers or the number of alighting passengers that is more accurate can be predicted on the basis of the proportion.

According to the boarding and alighting number prediction device 1, congested bus sending-off recommendation with boarding and alighting passengers taken into account can be realized.

As a background, in the COVID-19 pandemic, there is a demand for avoiding congested situations. There are cases in which congestion is concentrated on some of buses although a following bus has vacancy. Schedule disruptions due to traffic conditions may occur particularly in buses.

As a problem, in an existing technology, for example, boarding and alighting passengers are not taken into account. Even in a case in which congestion occurs at the time of arrival, when many persons gets off the bus, there is no congestion. Even in a case in which there is no congestion at the time of arrival, when may persons gets in the bus, congestion occurs. In addition, since user demographics vary for each bus stop, a deviation occurs in the amount of data that can be acquired in real time. In the case of bus stops that are frequently used on a daily basis and bus stops that are sporadically used, the former is considered to be more actively engaged in bus use through various services (bus applications and the like). The use of real-time data is not limited to be necessarily effective for all the bus stops.

According to the boarding and alighting number prediction device 1, it is predicted whether “a bus arriving at a corresponding bus stop” will be “congested at the time of departure from the corresponding bus stop”, and in a case in which there is a following bus having vacancy, a sending-off recommendation of a congested bus is performed. The boarding and alighting number prediction device 1 may use the followings in congestion prediction.
The number of passengers on board before arrival at a specific bus stop
The number of passengers to alight at a specific bus stop
The number of passengers to board at a specific bus stop

According to the boarding and alighting number prediction device 1, the boarding and alighting number is optimized on the basis of real-time data and past accumulation data for each bus stop.

The boarding and alighting number prediction device 1 may be a system that performs congested bus sending-off recommendation with the numbers of on-board passengers of a plurality of buses arriving at a bus stop and the estimated number of alighting passengers and the estimated number of boarding passengers at the arrival bus stop taken into account. A method executed by the boarding and alighting number prediction device 1 may be a method performing estimation of the number of boarding passengers and estimation of the number of alighting passengers that can be appropriately utilized (optimized) for each bus stop, each day, and each time frame on the basis of real-time data and past result data. The boarding and alighting number prediction device 1 may utilize past data for estimating the number of boarding passengers. The boarding and alighting number prediction device 1 may utilize past data for estimating the number of alighting passengers.

The boarding and alighting number prediction device 1 according to the present disclosure has the following configuration.

[1] A boarding and alighting number prediction device comprising a prediction unit predicting a boarding and alighting number prediction value that is a predicted value of a boarding and alighting number that is the number of boarding passengers or the number of alighting passengers at a stop on the basis of a real-time prediction value that is a predicted value of the boarding and alighting number based on position information relating to current positions of at least some of the passengers and past result values that are values based on result values of past boarding and alighting numbers.

[2] The boarding and alighting number prediction device described in [1], in which the prediction unit predicts the boarding and alighting number prediction value by respectively weighting the real-time prediction value and the past result values.

[3] The boarding and alighting number prediction device described in [2], further comprising an update unit updating weights on the basis of a difference between the boarding and alighting number prediction value and the actual boarding and alighting number.

[4] The boarding and alighting number prediction device described in any one of [1] to [3], in which the real-time prediction value and the past result values are targeted for a same day of week or a same time period.

[5] The boarding and alighting number prediction device described in any one of [1] to [4], further comprising a recommendation unit recommending the passengers waiting for boarding at the stop to send off boarding on the basis of the boarding and alighting number prediction value predicted by the prediction unit.

[6] The boarding and alighting number prediction device described in any one of [1] to [5], in which the position information is information representing that mobile devices held by at least some of the passengers have checked in at certain stops.

[7] The boarding and alighting number prediction device described in any one of [1] to [6], in which the prediction unit calculates the real-time prediction value on the basis of a proportion providing the position information among the passengers.

Each block diagram used for description of the embodiment described above illustrates blocks in units of functions. Such functional blocks (component units) are realized by an arbitrary combination of at least one of hardware and software. In addition, a method for realizing each functional block is not particularly limited. In other words, each functional block may be realized by using one device that is combined physically or logically or using a plurality of devices by directly or indirectly (for example, using a wire or wirelessly) connecting two or more devices separated physically or logically. A functional block may be realized by one device or a plurality of devices described above and software in combination.

As functions, there are deciding, determining, judging, computing, calculating, processing, deriving, inspecting, searching, checking, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like, and the functions are not limited thereto. For example, a functional block (constituent unit) enabling transmission to function is referred to as a transmitting unit or a transmitter. As described above, a method for realizing all the functions is not particularly limited.

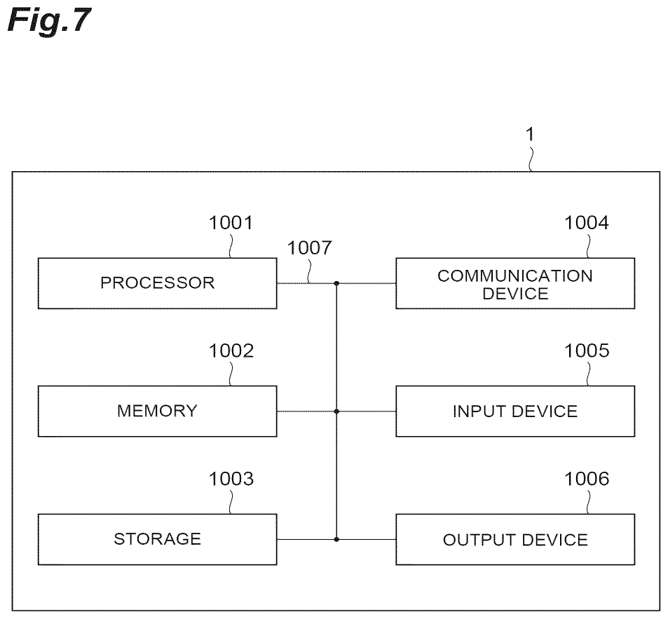

For example, the boarding and alighting number prediction device 1 and the like according to one embodiment of the present disclosure may function as a computer that performs the process of the boarding and alighting number prediction method according to the present disclosure. FIG. 7 is a diagram illustrating an example of the hardware configuration of the boarding and alighting number prediction device 1 according to one embodiment of the present disclosure. The boarding and alighting number prediction device 1 described above, physically, may be configured as a computer device including a processor 1001, a memory 1002, a storage 1003, a communication device 1004, an input device 1005, an output device 1006, a bus 1007, and the like.

In addition, in the following description, a term “device” may be rephrased as a circuit, a device, a unit, or the like. The hardware configuration of the boarding and alighting number prediction device 1 may be configured to include one or a plurality of devices illustrated in the drawing and may be configured without including some of these devices.

Each function of the boarding and alighting number prediction device 1 may be realized when the processor 1001 performs an arithmetic operation by causing predetermined software (a program) to be read onto hardware such as the processor 1001, the memory 1002, and the like, controls communication using the communication device 1004, and controls at least one of data reading and data writing for the memory 1002 and the storage 1003.

The processor 1001, for example, controls the entire computer by operating an operating system. The processor 1001 may be configured by a central processing unit (CPU) including an interface with peripheral devices, a control device, an arithmetic operation device, a register, and the like. For example, the acquisition unit 11, the prediction unit 12, the update unit 13, the recommendation unit 14, and the like described above may be realized by the processor 1001.

In addition, the processor 1001 reads a program (program code), a software module, data, and the like from at least one of the storage 1003 and the communication device 1004 into the memory 1002 and executes various processes in accordance with these. As the program, a program causing a computer to execute at least some of the operations described in the embodiment described above is used. For example, the acquisition unit 11, the prediction unit 12, the update unit 13, and the recommendation unit 14 may be realized by a control program that is stored in the memory 1002 and operated by the processor 1001, and other functional blocks may be realized similarly as well. Although the various processes described above have been described as being executed by one processor 1001, the processes may be executed simultaneously or sequentially by two or more processors 1001. The processor 1001 may be realized using one or more chips. In addition, the program may be transmitted from a network through a telecommunication line.

The memory 1002 is a computer-readable recording medium and, for example, may be configured by at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), or the like. The memory 1002 can store a program (a program code), a software module, and the like executable for performing a radio communication method according to one embodiment of the present disclosure.

The storage 1003 is a computer-readable recording medium and, for example, may be configured by at least one of an optical disc such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above, for example, may be a database including at least one of the memory 1002 and a storage 1003, a server, or any other appropriate medium.

The communication device 1004 is hardware (a transmission/reception device) for performing inter-computer communication through at least one of a wired network and a wireless network and, for example, may be called also a network device, a network controller, a network card, a communication module, or the like. The communication device 1004, for example, in order to realize at least one of frequency division duplex (FDD) and time division duplex (TDD), may be configured to include a high frequency switch, a duplexer, a filter, a frequency synthesizer, and the like. For example, the acquisition unit 11, the prediction unit 12, the update unit 13, the recommendation unit 14, and the like described above may be realized using the communication device 1004.

The input device 1005 is an input device (for example, a keyboard, a mouse, a microphone, a switch, buttons, a sensor, or the like) that accepts an input from the outside. The output device 1006 is an output device (for example, a display, a speaker, an LED lamp, or the like) that performs output to the outside. In addition, the input device 1005 and the output device 1006 may have an integrated configuration (for example, a touch panel).

In addition, devices such as the processor 1001, the memory 1002, and the like are connected using a bus 1007 for communication of information. The bus 1007 may be configured as a single bus or buses different between devices.

In addition, the boarding and alighting number prediction device 1 may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by the hardware. For example, the processor 1001 may be mounted using at least one of such hardware components.

Notification of information is not limited to an aspect/embodiment described in the present disclosure and may be performed using a difference method.

Each aspect/embodiment described in the present disclosure may be applied to at least one of long term evolution (LTE), LTE-advanced (LTE-A), Super 3G, IMT-advanced, 4G (a 4th generation mobile communication system), 5G (a 5th generation mobile communication system), future ratio access (FRA), NR (New Radio), W-CDMA (registered trademark), GSM (registered trademark), CDMA 2000, ultra mobile broadband (UMB), IEEE 802.11 (Wi-Fi (registered trademark)), IEEE 802.16 (WiMAX (registered trademark)), IEEE 802.20, ultra-wideband (UVB), Bluetooth (registered trademark), a system using another appropriate system and a next generation system extended based on these. In addition, a plurality of systems may be combined (for example, a combination of at least one of LTE and LTE-A and 5G or the like) for an application.

The processing sequence, the sequence, the flowchart, and the like of each aspect/embodiment described in the present disclosure may be changed in order as long as there is no contradiction. For example, in a method described in the present disclosure, elements of various steps are presented in an exemplary order, and the method is not limited to the presented specific order.

The input/output information and the like may be stored in a specific place (for example, a memory) or managed using a management table. The input/output information and the like may be overwritten, updated, or added to. The output information and the like may be deleted. The input information and the like may be transmitted to another device.

A judgment may be performed using a value (“0” or “1”) represented by one bit, may be performed using a Boolean value (true or false), or may be performed using a comparison between numerical values (for example, a comparison with a predetermined value).

The aspects/embodiments described in the present disclosure may be individually used, used in combination, or be switched therebetween in accordance with execution. In addition, a notification of predetermined information (for example, a notification of being X) is not limited to being performed explicitly and may be performed implicitly (for example, a notification of the predetermined information is not performed).

As above, while the present disclosure has been described in detail, it is apparent to a person skilled in the art that the present disclosure is not limited to the embodiments described in the present disclosure. The present disclosure may be modified or changed without departing from the concept and the scope of the present disclosure set in accordance with the claims. Thus, the description presented in the present disclosure is for the purpose of exemplary description and does not have any limited meaning for the present disclosure.

It is apparent that software, regardless of whether it is called software, firmware, middleware, a microcode, a hardware description language, or any other name, may be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, information, and the like may be transmitted and received via a transmission medium. For example, in a case in which software is transmitted from a website, a server, or any other remote source using at least one of a wiring technology such as a coaxial cable, an optical fiber cable, a twisted pair, a digital subscriber line (DSL) or the like and a radio technology such as infrared rays, radio waves, microwaves, or the like, at least one of such a wiring technology and a radio technology is included in the definition of the transmission medium.

Information, a signal, and the like described in the present disclosure may be represented using any one among other various technologies. For example, data, an instruction, a command, information, a signal, a bit, a symbol, a chip, and the like described over the entire description presented above may be represented using a voltage, a current, radiowaves, a magnetic field or magnetic particles, an optical field or photons, or an arbitrary combination thereof.

In addition, a term described in the present disclosure and a term that is necessary for understanding the present disclosure may be substituted with terms having the same meaning or a meaning similar thereto.

Terms such as “system” and “network” used in the present disclosure are interchangeably used.

In addition, information, a parameter, and the like described in the present disclosure may be represented using absolute values, relative values with respect to predetermined values, or other corresponding information.

A name used for each parameter described above is not limited in any aspect. In addition, numerical equations using such parameters may be different from those that are explicitly disclosed in the present disclosure.

Terms such as “determining” used in the present disclosure may include various operations of various types. The “deciding” and “determining”, for example, may include a case in which judging, calculating, computing, processing, deriving, investigating, looking up, search, and inquiry (for example, looking up a table, a database, or any other data structure), or ascertaining is regarded as “deciding” and “determining”. In addition, “deciding” and “determining” may include a case in which receiving (for example, receiving information), transmitting (for example, transmitting information), input, output, or accessing (for example, accessing data in a memory) is regarded as “deciding” and “determining”. Furthermore, “deciding” and “determining” may include a case in which resolving, selecting, choosing, establishing, comparing, or the like is regarded as “deciding” and “determining”. In other words, “deciding” and “determining” includes case in which a certain operation is regarded as “deciding” and “determining”. In addition, “deciding (determining)” may be rephrased with “assuming”, “expecting”, “considering”, and the like.

Terms such as “connected” or “coupled” or all the modifications thereof mean all the kinds of direct or indirect connection or coupling between two or more elements and may include presence of one or more intermediate elements between two elements that are mutually “connected” or “coupled”. Coupling or connection between elements may be physical coupling or connection, logical coupling or connection, or a combination thereof. For example, “connection” may be rephrased with “access”. When used in the present disclosure, two elements may be considered as being mutually “connected” or “coupled” by using one or more wires and at least one of a cable and a print electric connection and, as several non-limiting and non-comprehensive examples, by using electromagnetic energy such as electromagnetic energy having wavelengths in a radio frequency region, a microwave region, and a light (both visible light and non-visible light) region.

Description of “on the basis of” used in the present disclosure does not mean “only on the basis of” unless otherwise mentioned. In other words, description of “on the basis of” means both “only on the basis of” and “on the basis of at least.”

In the present disclosure, in a case in which names such as “first”, “second”, and the like is used, referring to each element does not generally limit the amount or the order of such an element. Such names may be used in the present disclosure as a convenient way for distinguishing two or more elements from each other. Accordingly, referring to the first and second elements does not mean that only the two elements are employed therein or the first element should precede the second element in a certain form.

“Means” in the configuration of each device described above may be substituted with “unit”, “circuit”, “device”, or the like.

In a case in which “include,” “including,” and modifications thereof are used in the present disclosure, such terms are intended to be inclusive like a term “comprising.” In addition, a term “or” used in the present disclosure is intended to be not an exclusive logical sum.

In the present disclosure, for example, in a case in which an article such as “a,” “an,” or “the” in English is added through a translation, the present disclosure may include a plural form of a noun following such an article.

In the present disclosure, a term “A and B are different” may mean that “A and B are different from each other”. In addition, the term may mean that “A and B are different from C”. Terms “separated”, “combined”, and the like may be interpreted similar to “different”.

### REFERENCE SIGNS LIST

1 . . . Boarding and alighting number prediction device, 10 . . . Storage unit, 11 . . . Acquisition unit, 12 . . . Prediction unit, 13 . . . Update unit, 14 . . . Recommendation unit, 1001 . . . Processor, 1002 . . . Memory, 1003 . . . Storage, 1004 . . . Communication device, 1005 . . . Input device, 1006 . . . Output device, 1007 . . . Bus.

1. A boarding and alighting number prediction device comprising processing circuitry configured to predict a boarding and alighting number prediction value that is a predicted value of a boarding and alighting number that is the number of boarding passengers or the number of alighting passengers at a stop on the basis of a real-time prediction value that is a predicted value of the boarding and alighting number based on position information relating to current positions of at least some of the passengers and past result values that are values based on result values of past boarding and alighting numbers.

2. The boarding and alighting number prediction device according to claim 1, wherein the processing circuitry is configured to predict the boarding and alighting number prediction value by respectively weighting the real-time prediction value and the past result values.

3. The boarding and alighting number prediction device according to claim 2, wherein the processing circuitry is further configured to update weights on the basis of a difference between the boarding and alighting number prediction value and the actual boarding and alighting number.

4. The boarding and alighting number prediction device according to claim 1, wherein the real-time prediction value and the past result values are targeted for a same day of week or a same time period.

5. The boarding and alighting number prediction device according to claim 1, wherein the processing circuitry is further configured to recommend the passengers waiting for boarding at the stop to send off boarding on the basis of the predicted boarding and alighting number prediction value.

6. The boarding and alighting number prediction device according to claim 1, wherein the position information is information representing that mobile devices held by at least some of the passengers have checked in at certain stops.

7. The boarding and alighting number prediction device according to claim 1, wherein the processing circuitry is configured to calculate the real-time prediction value on the basis of a proportion providing the position information among the passengers.

8. The boarding and alighting number prediction device according to claim 2, wherein the real-time prediction value and the past result values are targeted for a same day of week or a same time period.

9. The boarding and alighting number prediction device according to claim 3, wherein the real-time prediction value and the past result values are targeted for a same day of week or a same time period.

10. The boarding and alighting number prediction device according to claim 2, wherein the processing circuitry is further configured to recommend the passengers waiting for boarding at the stop to send off boarding on the basis of the predicted boarding and alighting number prediction value.

11. The boarding and alighting number prediction device according to claim 3, wherein the processing circuitry is further configured to recommend the passengers waiting for boarding at the stop to send off boarding on the basis of the predicted boarding and alighting number prediction value.

12. The boarding and alighting number prediction device according to claim 2, wherein the position information is information representing that mobile devices held by at least some of the passengers have checked in at certain stops.

13. The boarding and alighting number prediction device according to claim 3, wherein the position information is information representing that mobile devices held by at least some of the passengers have checked in at certain stops.

14. The boarding and alighting number prediction device according to claim 2, wherein the processing circuitry is configured to calculate the real-time prediction value on the basis of a proportion providing the position information among the passengers.

15. The boarding and alighting number prediction device according to claim 3, wherein the processing circuitry is configured to calculate the real-time prediction value on the basis of a proportion providing the position information among the passengers.
